(19) United States
(12) Patent Application Publication
(10) Pub. No.: US 2011/0215970 A1
(43) Pub. Date: Sep. 8, 2011

(54) HIGH-FREQUENCY PACKAGE

(75) Inventor: Yasuaki ASAHI, Kanagawa-ken (JP)

(73) Assignee: KABUSHIKI KAISHA TOSHIBA, Tokyo (JP)

(21) Appl. No.: 12/945,294

(22) Filed: Nov. 12, 2010

(30) Foreign Application Priority Data
Mar. 5, 2010 (JP) 2010-049329

(51) Int. Cl. H01Q 1/38

(52) U.S. Cl. 343/700 MS

(57) ABSTRACT

Certain embodiments provide a high-frequency package comprising: a conductive member to have a cut portion; a package to have a high-frequency device; a signal lead drawn from the package and is connected with the high-frequency device; a substrate to have a microstrip line comprising a microstrip line pattern in contact with the signal lead, a dielectric and an earth conductor; and a ground lead provided in the cut portion and directly below the signal lead, to contact the earth conductor and hold the substrate in cooperation with the signal lead.

### CROSS-REFERENCE TO RELATED APPLICATION

The present application claims priority under 35U.S.C. 119 to Japanese Patent Application Ser. No. 2010-049329, filed on Mar. 5, 2010, the entire disclosure of which is incorporated herein by reference.

### FIELD

An embodiment relates to a high-frequency package.

### BACKGROUND

In a related art, there has been known a high-frequency package constituted of, for example, a metal base plate and a rectangular frame-shaped dielectric frame disposed on the metal base plate. The high-frequency package has circuit components on the inside of the metal base plate surrounded by the dielectric frame on the metal base plate. There has been proposed an apparatus using the high-frequency package in a high output electric power amplifying device.

FIGS. 5A and 5B show a structural example of a package according to the related art for a semiconductor device used in a high-frequency band such as a microwave band and a millimeter wave band. FIG. 5A is a plan view of a high-frequency package, and FIG. 5B is a sectional front view of the high-frequency package as taken along line D-D′ of FIG. 5A. In a metal case 50, a recess 52 is formed in a surface portion 51, and a package 54 with a built-in high-frequency device 53 is accommodated in the recess 52. The package 54 has a package housing 55 and an upper lid 56 covering the package housing 55. The package housing 55 includes in part a rectangular frame-shaped dielectric frame. The high-frequency device 53 is externally surrounded and sealed by the upper lid 56, a bottom portion 57, and a wall portion 58.

Both input and output sides of the package 54 have a field through portion 59 for transmitting a signal power inside and outside the package 54. Each of the field through portions 59 is connected to a dielectric substrate 60, a microstrip line substrate 61 on the surface portion 51, and a signal lead 62 electrically connecting between the dielectric substrate 60 and the microstrip line substrate 61. The left side end of the signal lead 62 is connected to a line pattern 63 of the microstrip line substrate 61. The right side end of the signal lead 62 penetrates through the wall portion 58 and is connected to the high-frequency device 53. The microstrip line substrate 61 has the line pattern 63, other dielectric substrate 64 provided under the line pattern 63, and a ground pattern 65 on the rear side of the dielectric substrate 64.

In the related art, there has been known a high-frequency device package in which a high-frequency device is accommodated in a housing as well as the high-frequency device and a microstrip line are grounded on the housing. The high-frequency device package accommodates grounds continuous at input/output connection points on the housing side and the high-frequency package side to reduce the passage loss.

### BRIEF DESCRIPTION OF THE DRAWINGS

FIG. 1A is a plan view of a high-frequency package according to a first embodiment;

FIG. 1B is a sectional front view of the high-frequency package according to the first embodiment;

FIG. 2A is a plan view of a recess provided on a conductive member;

FIG. 2B is a front view of a package;

FIG. 2C is a view showing a cross-sectional structure of the high-frequency package;

FIG. 3A is a plan view of a high-frequency package according to a second embodiment;

FIG. 3B is a sectional front view of the high-frequency package according to the second embodiment;

FIG. 4 is a package front view of a high-frequency package according to a third embodiment;

FIG. 5A is a plan view of a high-frequency package according to a related art; and

FIG. 5B is a sectional front view of the high-frequency package of FIG. 5A.

### DETAILED DESCRIPTION

Certain embodiments provide a high-frequency package comprising: a conductive member configured to have a surface, a recess provided on the surface, and a cut portion formed in the recess; a package configured to have a dielectric member surrounding a part of a space in the recess of the conductive member and a high-frequency device provided in the dielectric member; a signal lead configured to be drawn from the package and is connected with the high-frequency device; a substrate configured to have a microstrip line comprising a microstrip line pattern in contact with the signal lead and an earth conductor facing the microstrip line pattern through a dielectric and in contact with the surface of the conductive member; and a ground lead configured to be provided in the cut portion and directly below the signal lead, contact the earth conductor of the substrate and hold the substrate in cooperation with the signal lead.

For the sake of accommodating the package housing 55 in the recess 52, however, a gap portion 66 exists between a side surface portion of the package housing 55 and a rising wall portion of the recess 52. In the above related art, because of a recess depth, a distance between a ground surface of the package housing 55 and a ground surface of a ground pattern 65 of the microstrip line substrate 61 is increased. The path length of a path L is increased. A line impedance becomes discontinuous at a gap portion between the side surface portion and the rising wall portion, so that a standing wave ratio (SWR) is deteriorated, and band widening is difficult.

If the gap portions 66 exist respectively on the left and right sides of the package 54, the thickness of a dielectric layer (air) that determines a characteristic impedance is rapidly changed due to the recess depth. The continuity of the characteristic impedance is reduced. A traveling wave is reflected at a discontinuous point of the characteristic impedance. The standing wave ratio of a high frequency wave is deteriorated. Because of the deterioration of the standing wave ratio, to widen the bandwidth of the package 54 is difficult.

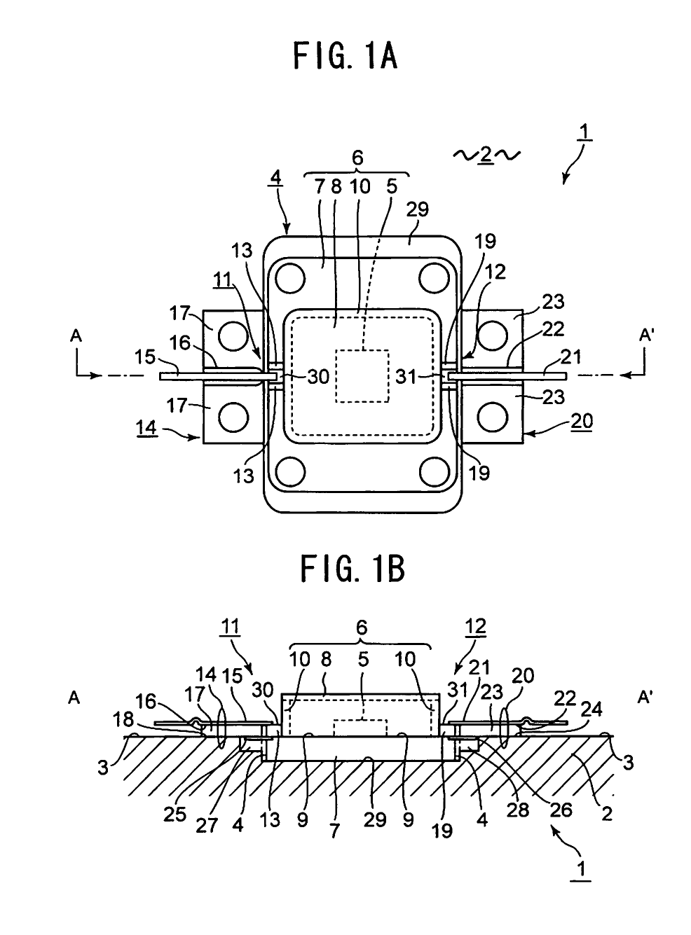

Hereinafter, a high-frequency package according to an embodiment will be described with reference to FIGS. 1 to 4B. In each drawing, the same components are designated the same reference numerals, and overlapping descriptions thereof are omitted.

### First Embodiment

FIG. 1A is a plan view of a high-frequency package according to a first embodiment. FIG. 1B is a sectional front view of the high-frequency package according to the first embodiment and shows a cross-sectional structure as taken along a line AA′ of FIG. 1A. A high-frequency package 1 is a high-frequency semiconductor package. The high-frequency package 1 includes a metal conductive member having a recess, a dielectric frame (a dielectric member), a semiconductor circuit provided on the dielectric frame, and a high-frequency input/output terminal which supplies an input signal to the semiconductor circuit and outputs an output signal from the semiconductor circuit.

A case 2 is an earth conductor (a conductive member) for a high-frequency signal and is formed of aluminum and copper and the like. The case 2 has a recess 4 counterbored is in the form of a concave to a depth relative to a surface portion 3 of the case 2. The recess 4 accommodates a package 6 sealed in a state of accommodating a high-frequency device 5. The package 6 includes a package housing 7 having a package thickness and an upper lid 8 pairing with the package housing 7 and sealing the high-frequency device 5.

As an example of the package housing 7, a package housing includes in part a rectangular frame-shaped dielectric frame. The high-frequency package 1 fixes the package housing 7 by fastening with screws through holes as represented by circles to the case 2. The high-frequency device 5 is externally surrounded by the upper lid 8, a bottom portion 9, and a wall portion 10 each including in part a dielectric member. The package 6 includes a dielectric member surrounding a part of a space in the recess 4 and a high-frequency device provided in the dielectric member.

The package 6 has field through portions 11 and 12 for transmitting a signal inside and outside. The field through portion 11 on the left side of the drawing has a dielectric substrate 13, a microstrip line substrate 14 (a substrate) located on the surface portion 3, and a signal lead 15 electrically connecting between the dielectric substrate 13 and the microstrip line substrate 14. The left side end of the signal lead 15 is connected to a line pattern 16 (a microstrip line pattern) of the microstrip line substrate 14. The right side end of the signal lead 15 is connected to a signal electrode 30. The signal electrode 30 f.e. penetrates the wall portion 10 without shunting with a conductor portion of the wall portion 10 to thereby be connected to the high-frequency device 5 through a bonding wire (not shown).

The microstrip line substrate 14 has the line pattern 16, a dielectric substrate 17 (a dielectric) located on the rear side of the line pattern 16, and a ground pattern 18 (an earth conductor) located on the rear surface side of the dielectric substrate 17. The dielectric substrates 13 and 17 are formed of alumina, for example. The signal lead 15 is formed of kovar, for example.

The right field through portion 12 has a dielectric substrate 19, a microstrip line substrate 20 (a substrate) on the surface portion 3, and a signal lead 21 (a microstrip line pattern) electrically connecting between the dielectric substrate 19 and the microstrip line substrate 20. The right side end of the signal lead 21 is connected to a line pattern 22 (a microstrip line pattern) of the microstrip line substrate 20. The left side end of the signal lead 21 is connected to a signal electrode 31. The signal electrode 31 is connected to the high-frequency device 5 by wire bonding. The microstrip line substrate 20 has the line pattern 22, a dielectric substrate 23 (a dielectric) located on the rear side of the line pattern 22, and a ground pattern 24 (an earth conductor) located on the rear surface side of the dielectric substrate 23. The dielectric substrates 19 and 23 are formed of alumina, for example. The signal lead 21 is formed of kovar, for example.

The line pattern 16 of the microstrip line substrate 14 and the line pattern 22 of the microstrip line substrate 20 are microstrip lines connecting with the high-frequency device 5. The ground pattern 18 of the microstrip line substrate 14 and the ground pattern 24 of the microstrip line substrate 20 are earth conductors. The ground pattern 18 faces the signal lead 15 and holds the dielectric substrate 17 therebetween. The ground pattern 24 faces the signal lead 21 and holds the dielectric substrate 23 therebetween.

In the first embodiment, the high-frequency package 1 has a ground lead 25 (a bias lead) connected to the ground pattern 18 directly below the signal lead 15. The high-frequency package 1 has a ground lead 26 (a bias lead) connected to the ground pattern 24 directly below the signal lead 21. The ground leads 25 and 26 are drawn from the package housing 7 to the outside of the package housing 7. The ends of the ground leads 25 and 26 are respectively soldered to the lower surface sides of the microstrip line substrates 14 and 20.

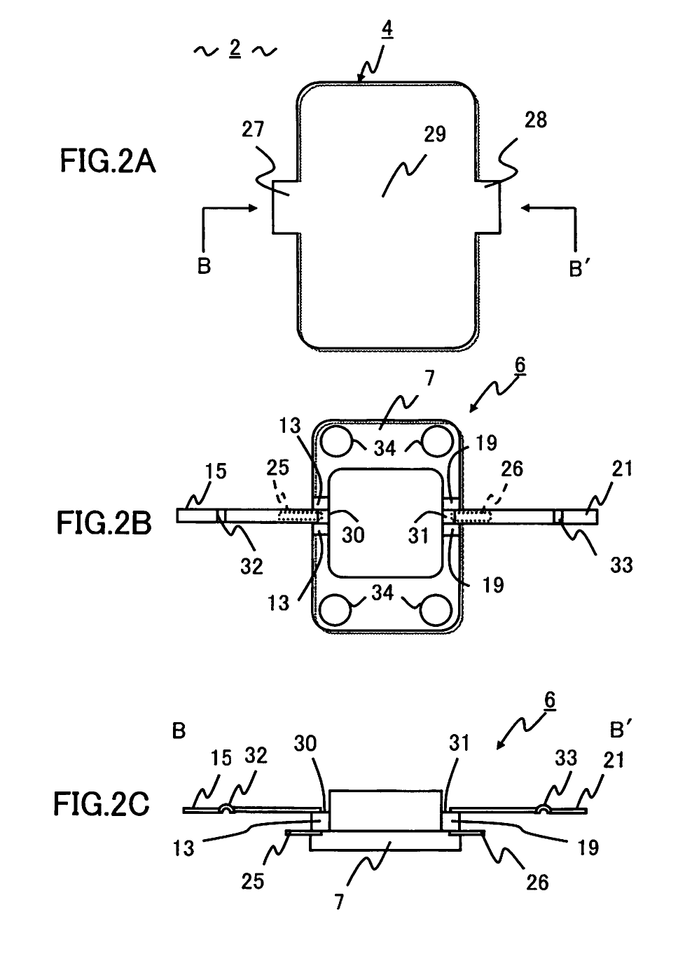

FIG. 2A is a plan view of the recess 4 provided on the case 2. FIG. 2B is a front view of the package 6. FIG. 2C shows a cross-sectional structure of the high-frequency package 1 as taken along a line BB′ of FIG. 2A when the package 6 is accommodated in the recess 4. In those drawings, the components designated by the same reference numerals represent the same components. The components designated by the same reference numerals as those described above represent the same components. A reference numeral 34 represents a hole for fixing with screws.

The recess 4 has cut portions 27 and 28. The cut portions 27 and 28 are arranged along a recess length direction (the horizontal direction in the same drawing). A recess bottom surface 29 is a mounting surface of the package 6. The recess bottom surface 29 has rising wall portions surrounded on four sides rising from the recess bottom surface 29. The two rising wall portions facing in the recess length direction respectively have the cut portions and 28. The high-frequency package 1 projects protruding objects downward from the lower surfaces of the microstrip line substrates 14 and 20. The protruding objects can be accommodated in the recess 4 without butting against a case surface 3.

The ground leads 25 and 26 are pin-like lead pins. The ground leads 25 and 26 may uses a metal piece in the form of a thin plate piece or a thin line-like lead. As shown in FIGS. 2B and 2C, the high-frequency package 1 fixes an upper surface of the ground lead 25 and a lower surface of the dielectric substrate 13 of the package housing 7 to each other by brazing, for example. The high-frequency package 1 connects the upper surface and the lower surface electrically. The upper surface of the ground lead 25 and a lower surface of the ground pattern 18 of the microstrip line substrate 14 are soldered to each other.

An upper surface of the ground lead 26 and a lower surface of the dielectric substrate 19 of the package housing 7 are electrically connected to each other by brazing, for example. The upper surface of the ground lead 26 and a lower surface of the ground pattern 24 of the microstrip line substrate 20 are soldered to each other.

The high-frequency package 1 has the signal electrodes 30 and 31 respectively on the dielectric substrates 13 and 19. The high-frequency package 1 wire-connects the signal electrodes 30 and 31 to the internally located high-frequency device 5 by wire bonding. The wire connection is performed by a wiring passing through a through-hole (not shown) of the wall portion 10. When the package housing 7 has a laminate structure of a dielectric frame, the high-frequency package 1 may performs the wire connection by interlayer wiring.

In the first embodiment, the high-frequency package 1 connects the signal lead 15 to the signal electrode 30. The high-frequency package 1 connects the signal lead 21 to the signal electrode 31. The signal leads 15 and 21 have lead forming portions 32 and 33. With the lead forming portions 32 and 33, the signal leads 15 and 21 absorb mechanical stresses due to thermal expansion and contraction.

When the package 6 is accommodated in the recess 4, the high-frequency package 1 accommodates the ground lead 25 in the cut portion 27 formed so as to be positioned at the ground lead 25. The high-frequency package 1 accommodates the ground lead 26 in the cut portion 28 formed so as to be positioned at the ground lead 26. The high-frequency package 1 holds the microstrip line substrate 14 between the signal lead 15 and the ground lead 25. The ground lead 25 positions directly below the signal lead 15 as well as in the cut portion 27. The high-frequency package 1 holds the microstrip line substrate 20 between the signal lead 21 and the ground lead 26. The ground lead 26 positions directly below the signal lead 21 as well as in the cut portion 28.

In the high-frequency package 1 (FIGS. 1A and 1B) having the above constitution, the right field through portion 12 is connected to the input terminal side receiving a high-frequency signal, and the left field through portion 11 is connected to the output terminal side.

As shown in FIG. 1A, on the input side, the signal lead 21, which is for RF (Radio Frequency) signal of the package 6, and the ground lead 26, which positions directly below the signal lead 21, vertically hold therebetween the microstrip line substrate 20. According to the constitution, the high-frequency package 1 keeps a distance between the signal lead 21 and a high-frequency ground constant. The discontinuity of the line impedance can be reduced, so that the standing wave ratio can be improved. Also on the output side, the signal lead 15 and the ground lead 25 vertically hold therebetween the microstrip line substrate 14. According to the constitution, a distance between the signal lead 15 and the high-frequency ground is kept constant along an electric power transmission direction.

When an interval between a signal pattern of a high-frequency signal and a ground pattern of the high-frequency signal is constant along an electric power travel direction, a change in thickness of a dielectric layer in this direction can be reduced, and the discontinuity of the characteristic impedance can be improved. Thus, in the high-frequency package 1 according to the first embodiment, the standing wave ratio of the input/output portion is improved in comparison with the related art example. The bandwidth of a transmitter and receiver module using the high-frequency package 1 can be widened.

When the high-frequency package 1 is used in an environment with a large temperature difference, thermal expansion and contraction of components occur. The signal leads 15 and 21 may be subjected to application of a tension force in a horizontal direction, a compression force, a shearing force in a longitudinal direction, a twisting force around a lead core, or the like. By virtue of the lead forming portions 32 and 33, those residual stresses are absorbed. If there is no lead forming portion, a crack may occur in soldering joint. A force applied to the signal lead 15 or 21 causes a crack at a soldered portion of the signal lead 15 or 21, leading to braking. By virtue of the formation of the lead forming portions 32 and 33, even if the tension force or the like is applied to the signal leads 15 and 21, a solder crack can be made less likely to occur. The signal leads 15 and 21 have the lead forming portions 32 and 33, whereby the mechanical stress such as thermal expansion and contraction can be absorbed.

In the high-frequency package 1, a ground surface of the package housing 7 and ground surfaces of the microstrip line substrates 14 and 20 are wired within a close distance. The distance wiring between a ground contact surface of the package 6 and ground contact surfaces of the microstrip line substrates 14 and 20 is small relative to the wavelength of a signal. Thus, detouring from the wiring path conventionally occurring between the ground surface on the package side and the ground surface on the microstrip line substrate side is eliminated.

### Second Embodiment

In the first embodiment, the high-frequency package 1 has the single microstrip line substrates 14 and 20 such that the single microstrip line substrates 14 and 20 are connected to the input and output sides of the package 6. A high-frequency package according to an embodiment may include two microstrip line substrates on the input and output sides of the package 6. A high-frequency package according to the second embodiment has other microstrip line further in the high-frequency package 1 according to the first embodiment.

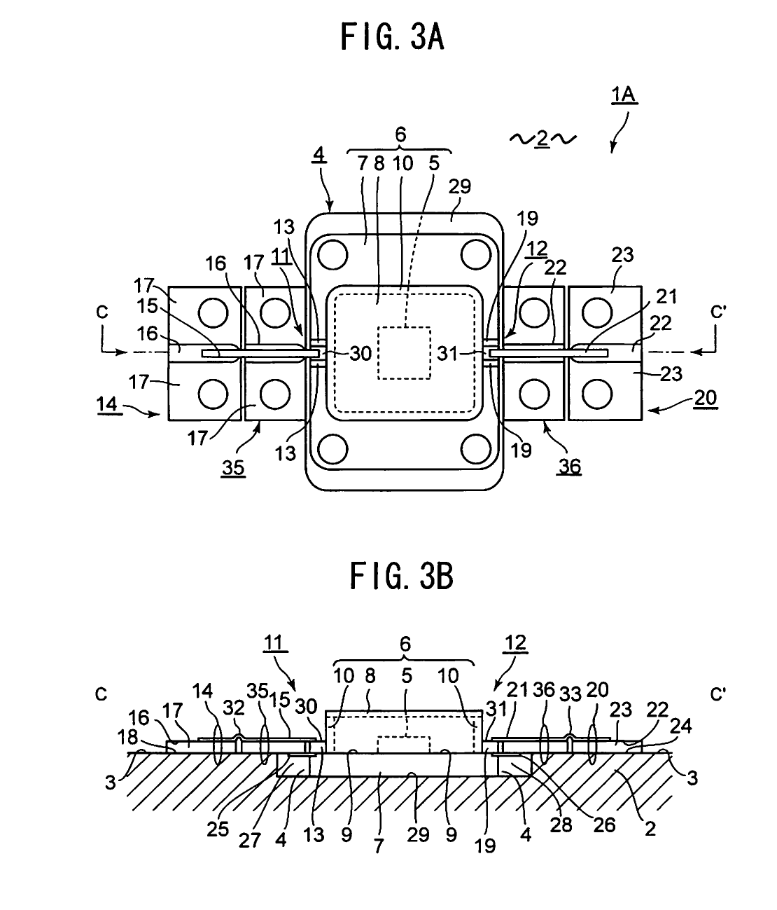

FIG. 3A is a plan view of the high-frequency package according to the second embodiment. FIG. 3B is a sectional front view of the high-frequency according to the second embodiment and shows a cross-sectional structure of the high-frequency package as taken along a line CC′ of FIG. 3A. For the reference numerals shown in FIGS. 3A to 3C, the components having the same reference numerals as those described above represent the same components. The level of cutting of the cut portions 27 and 28 is shown while being suitably changed.

A high-frequency package 1A is a high-frequency semiconductor package. The high-frequency package 1A accommodates a high-frequency device 5 in a recess 4 of a case 2. The high-frequency package 1A has an input/output terminal supplying an input signal to the high-frequency device 5 and outputting an output signal from the high-frequency device 5.

The high-frequency package 1A has a package attachment substrate 35 (an attachment substrate) having a substrate structure substantially the same as the substrate structure of a microstrip line substrate 14. The high-frequency package 1A connects the package attachment substrate 35 to a left field through portion 11. The high-frequency package 1A suitably adjusts the lead length of a signal lead 15 connecting between the package attachment substrate 35 and the microstrip line substrate 14. The package attachment substrate 35 has a line pattern 16, a dielectric substrate 17, and a ground pattern 18.

The high-frequency package 1A connects the left side end of the signal lead 15 to the line pattern 16 of the microstrip line substrate 14. The high-frequency package 1A connects an intermediate part of the signal lead 15 to the line pattern 16 of the package attachment substrate 35. The intermediate part indicates on the right side of a lead forming portion 32. The high-frequency package 1A connects the right side end of the signal lead 15 to a signal electrode 30. The high-frequency package 1A connects the signal electrode 30 to the high-frequency device 5 by, for example, penetrating through a wall portion 10.

Meanwhile, the high-frequency package 1A has a package attachment substrate 36 (an attachment substrate) having a substrate structure substantially the same as the substrate structure of a microstrip line substrate 20. The high-frequency package 1A connects the package attachment substrate 36 to a right field through portion 12. The high-frequency package 1A suitably adjusts the lead length of a signal lead 21 connecting between the package attachment substrate 36 and the microstrip line substrate 20. The package attachment substrate 36 has a line pattern 22, a dielectric substrate 23, and a ground pattern 24.

The high-frequency package 1A connects the right side end of the signal lead 21 to the line pattern 22 of the microstrip line substrate 20. The high-frequency package 1A connects an intermediate part of the signal lead 21 to the line pattern 22 of the package attachment substrate 36. The intermediate part indicates on the left side of a lead forming portion 33. The high-frequency package 1A connects the left side end of the signal lead 21 to a signal electrode 31. The high-frequency package 1A connects the signal electrode 31 to the high-frequency device 5 by, for example, penetrating through the wall portion 10.

Also in the second embodiment, the high-frequency package 1A connects a ground lead 25 to the ground pattern 18 of the left package attachment substrate 35. The ground lead 25 positions directly below the signal lead 15. The high-frequency package 1A connects a ground lead 26 to the ground pattern 24 of the right package attachment substrate 36. The ground lead 26 positions directly below the signal lead 21. The high-frequency package 1A draws the ground leads 25 and 26 from the package housing 7 to the outside of the package housing 7. An end of the ground lead 25 is soldered to the ground pattern 18 of the package attachment substrate 35. An end of the ground lead 26 is soldered to the ground pattern 24 of the package attachment substrate 36.

In the high-frequency package 1A having the above constitution according to the second embodiment, on the right input side, the signal lead 21 and the ground lead 26 vertically hold therebetween the package attachment substrate 36. The high-frequency package 1A keeps the distance between the signal lead 21 and the ground lead 26 constant. The discontinuity of the line impedance can be reduced, so that the standing wave ratio can be improved. On the output side, the signal lead 15 and the ground lead 25 vertically hold therebetween the package attachment substrate 35. The high-frequency package 1A keeps the distance between the signal lead 15 and the ground lead 25 constant along the electric power transmission direction. Since the signal leads 15 and 21 have the lead forming portions 32 and 33, the mechanical stress such as thermal expansion and contraction can be absorbed.

The ground lead 26 is soldered to the ground pattern 24 in such a state that the lower surface of the package 7, that is, the rear surface is turned upward. The ground lead 25 is soldered to the ground pattern 18. The front and rear of the soldered package 7 is reversed to be placed on the recess bottom surface 29. According to the constitution, an operator does not have to perform the process of soldering on the rear surface of the package 7. The operation of grounding on the rear surface side of the package 7 is difficult. According to the high-frequency package 1A, even when two input and output substrates are each provided, the grounding on the rear surface of the substrate, each outside the input and output can be reliably performed, and therefore, the standing wave ratio can be improved in comparison with the related art example.

### Third Embodiment

In the first and second embodiments, the high-frequency package 1 and the high-frequency package 1A may change the shapes of the ends of the ground leads 25 and 26.

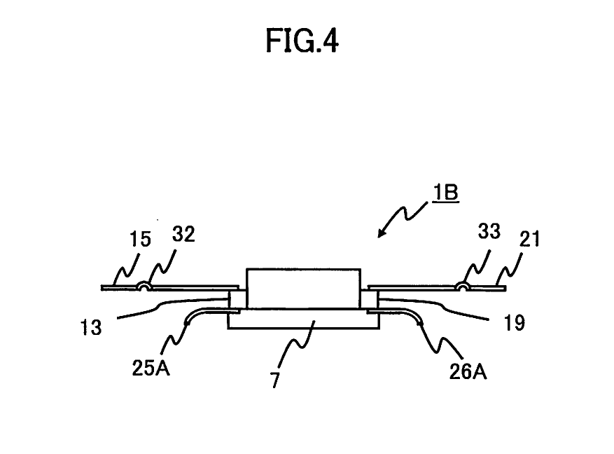

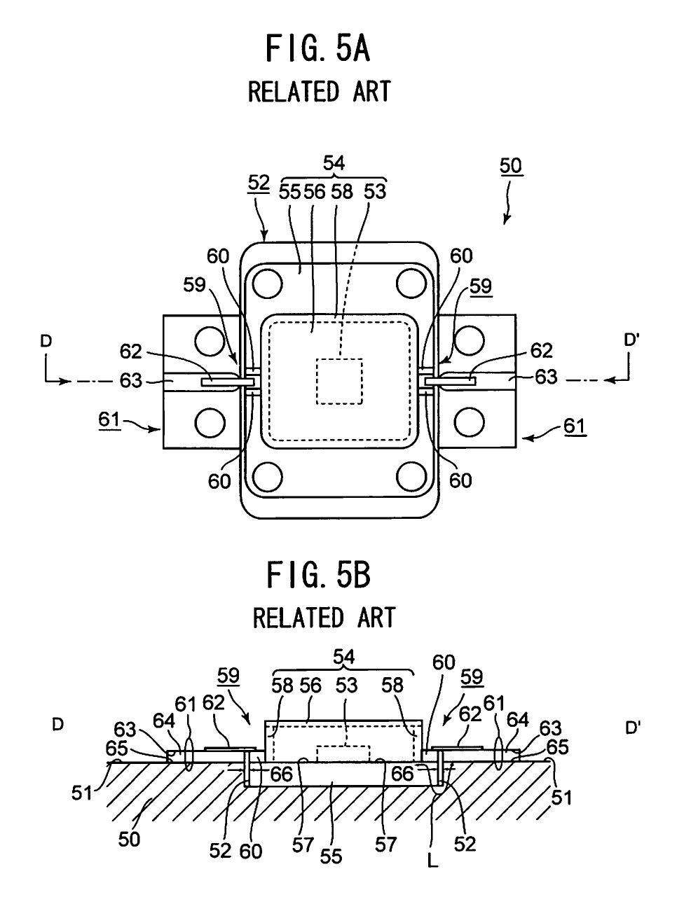

FIG. 4 is a package front view of a high-frequency package according to a third embodiment and shows a single package. Identical reference numerals denote identical components. The high-frequency package 1B attaches pin-like or thin plate-like ground leads 25A and 26A with a processed front end, both of which are processed to be bent in advance, to the package housing 7.

The ground lead 25A is soldered in a state of being held in advance in between the microstrip line substrate 14 of the high-frequency package 1 according to the first embodiment and the surface portion 3. Thereafter, f.e. a manufacturing machine presses the package 6 from above, whereby a high-frequency package 1B capable of performing high frequency grounding is obtained. The same holds for the case of the ground lead 26A with a bent front end.

The ground lead 25A having a bend front end is soldered in a state of being held in between the package attachment substrate 35 of the high-frequency package 1A according to the second embodiment and the surface portion 3. Thereafter, the manufacturing machine presses the held portion from above, whereby the high-frequency package 1B capable of performing high frequency grounding is obtained. The same holds for the case of the ground lead 26A with a bent front end.

According to the high-frequency package 1B of the third embodiment, by virtue of having the shape subjected to the bending process, a member for pressing and fixing is separately provided, for example, to thereby enable to increase a press-fitting force, and therefore, the grounding of the ground leads 25A and 26A can be further enhanced.

### Other Embodiment

In the example of FIGS. 3A and 3B, the signal leads 15 and 21 have the lead forming portions. However, in the high-frequency package 1A, even when the signal leads 15 and 21 have no lead forming portion, the standing wave ratio can be obviously improved.

While certain embodiments have been described, these embodiments have been presented by way of example only, and are not intended to limit the scope of the inventions. Indeed, the novel methods and systems described herein may be embodied in a variety of other forms; furthermore various omissions and substitutions and changes in the form of methods and systems described herein may be made without departing from the spirit of the inventions. The accompanying claims and their equivalents are intended to cover such forms or modifications as would fall within the scope and spirit of the inventions.

What is claimed is:

1. A high-frequency package comprising:
a conductive member configured to have a surface, a recess provided on the surface, and a cut portion formed in the recess;
a package configured to have a dielectric member surrounding a part of a space in the recess of the conductive member and a high-frequency device provided in the dielectric member;
a signal lead configured to be drawn from the package and is connected with the high-frequency device;
a substrate configured to have a microstrip line comprising a microstrip line pattern in contact with the signal lead and an earth conductor facing the microstrip line pattern through a dielectric and in contact with the surface of the conductive member; and
a ground lead configured to be provided in the cut portion and directly below the signal lead, contact the earth conductor of the substrate and hold the substrate in cooperation with the signal lead.

2. The high-frequency package of claim 1, the signal lead being subjected to lead-forming.

3. The high-frequency package of claim 1, further comprising:
an attachment substrate configured to have other microstrip line comprising other microstrip line pattern in contact with the signal lead and other earth conductor facing the other microstrip line pattern through other dielectric and contact the surface of the conductive member.

4. The high-frequency package of claim 2, further comprising:
an attachment substrate configured to have other microstrip line comprising other microstrip line pattern in contact with the signal lead and other earth conductor facing the other microstrip line pattern through other dielectric and contact the surface of the conductive member.

5. The high-frequency package of claim 1, further comprising:
a bias lead configured to be drawn from the package and apply a bias to the high-frequency device, the bias lead being subjected to lead-forming.

6. The high-frequency package of claim 1, further comprising:
a bias lead configured to be drawn from the package and apply a bias to the high-frequency device, an end of the bias lead being soldered to a ground contact surface of the substrate.

7. The high-frequency package of claim 1, further comprising:
a bias lead configured to be drawn from the package and apply a bias to the high-frequency device, an interval between the signal lead and the bias lead being constant along an electric power travel direction.

8. The high-frequency package of claim 1, a distance wiring between a ground contact surface of the package and a ground contact surface of the substrate being small relative to the wavelength of a signal.

9. The high-frequency package of claim 1, further comprising:
a bias lead configured to be drawn from the package and apply a bias to the high-frequency device, the bias lead being soldered in a state of being held in between the substrate and the surface, and the package being pressed from above by a force in the direction of the surface.

10. A high-frequency package comprising:
a conductive member configured to have a surface, a recess provided on the surface, and a cut portion formed in the recess;
a dielectric member configured to surround a part of a space in the recess;
a high-frequency device provided in the dielectric member;
a package configured to have the dielectric member and the high-frequency device;
a signal lead configured to be drawn from the package and is connected with the high-frequency device;
a first microstrip line configured to comprise a first microstrip line pattern in contact with the signal lead, and a first earth conductor facing the first microstrip line pattern through a first dielectric and in contact with the surface of the conductive member;
a substrate configured to have the first microstrip line; and
a ground lead configured to be provided in the cut portion and directly below the signal lead, contact the first earth conductor and hold the substrate in cooperation with the signal lead.

11. The high-frequency package of claim 10, the signal lead being subjected to lead-forming.

12. The high-frequency package of claim 10, further comprising:
a second microstrip line configured to comprise a second microstrip line pattern in contact with the signal lead, and a second earth conductor facing the second microstrip line pattern through a second dielectric and in contact with the surface of the conductive member; and
an attachment substrate configured to have the second microstrip line.

13. The high-frequency package of claim 11, further comprising:
a second microstrip line configured to comprise a second microstrip line pattern in contact with the signal lead, and a second earth conductor facing the second microstrip line pattern through a second dielectric and in contact with the surface of the conductive member; and
an attachment substrate configured to have the second microstrip line.

14. The high-frequency package of claim 10, further comprising:
a bias lead configured to be drawn from the package and apply a bias to the high-frequency device, the bias lead being subjected to lead-forming.

15. The high-frequency package of claim 10, further comprising:
a bias lead configured to be connected to the package, an end of the bias lead being soldered to a ground contact surface of the substrate.

16. The high-frequency package of claim 10, further comprising:
a bias lead configured to be connected to the package, an interval between the signal lead and the bias lead being constant along an electric power travel direction.

17. The high-frequency package of claim 10, a distance wiring between a ground contact surface of the package and a ground contact surface of the substrate being small relative to the wavelength of a signal.

18. The high-frequency package of claim 10, further comprising:
a bias lead configured to be connected to the package, the bias lead being soldered in a state of being held in between the substrate and the surface, and the package being pressed from above by a force in the direction of the surface.
